(19) United States
(12) Patent Application Publication
(10) Pub. No.: US 2018/0362299 A1
(43) Pub. Date: Dec. 20, 2018

(54) FASTENING DEVICES FOR FASTENING ELEVATOR RAILS

(71) Applicant: Inventio AG, Hergiswil (CH)

(72) Inventors: Frank Polinski, Root (CH); Martin Roeoesli, Stans (CH)

(21) Appl. No.: 16/063,343

(22) PCT Filed: Dec. 15, 2016
(86) PCT No.: PCT/EP2016/081305

§ 371 Date: Jun. 18, 2018

(30) Foreign Application Priority Data
Dec. 17, 2015 (EP) 15200951.0

(51) Int. Cl. B66B 7/02; B66B 19/00

(52) U.S. Cl. CPC B66B 7/024; B66B 19/002; B66B 7/021

(57) ABSTRACT

A fastening device, used to fasten a face of an elevator rail foot relative to a fastening plane, includes a support region and a contact region between which the face can be arranged. A compensation device, having a first element and a second element movable relative to each other in an adjustment direction, is used to fasten the face The first and second elements are formed such that, between the contact region and the support region, a holding dimension, viewed perpendicularly to the adjustment direction, in which a zero-backlash fastening of the face is enabled between the contact region and the support region, can be modified by a movement of the first element relative to the second element in the adjustment direction. The support region is formed on the first element. Alternatively or additionally, the support region is formed on at least one protrusion formed on the first element.

### FIELD

The invention relates to a fastening device used for fastening a face of a rail foot of an elevator rail relative to a fastening plane, and to an elevator system comprising one or more elevator rails that are mounted in an elevator shaft or the like using fastening devices of this type. Furthermore, the invention relates to a method for fastening a rail foot of an elevator rail, carried out using fastening devices of this type. Specifically, the invention relates to the field of elevator systems that are installed in tall buildings and extend over a large number of floors.

### BACKGROUND

DE-AS 1 139 254 relates to a guide-rail fastening apparatus for attaching guide rails of elevators to a supporting structure. This is based on the knowledge that it is advantageous for relative upward movements of the guide-rail portions to be made possible when buildings are settling. To make it easier for the building and the guide rail to move vertically relative to one another, fastening holes in the form of slots are made in a support plate in order for bolts for guide-rail clamps to be inserted therethrough, which clamps are removed from the adjacent ridge wall in an upward direction by the longitudinal axes thereof, guide-rail clamps being in contact with flanges of the guide rail in a resilient manner. If the length of the guide rail increases due to thermal expansion, then the forces transmitted to the bolts move the slidably aligned rail-fastening apparatus upwards, in order to reduce the friction between the guide-rail clamps and the guide rail, and this makes it easier for the guide rail to move vertically upwards relative to the guide-rail clamps.

The guide-rail fastening apparatus known from DE-AS 1 139 254 has the drawback that a direction-dependent change in the friction occurs. Specifically, if the opposite relative movement conversely occurs, for example due to temperature-related contraction of the guide rail, then the bolts are moved downwards into the slots, and this increases the friction between the guide-rail clamps and the guide rail, and prevents a relative vertical movement between the fastening apparatus and the rail. In addition, each movement of the bolt in the slot also leads to a change in the holding force or play in the guide rail on the fastening apparatus, which is undesired.

CH-PS 484 826 discloses a fastening apparatus for guide rails of elevators. This fastening apparatus is based on the knowledge that, when fastening guide rails for elevators, it needs to be taken into account that, in the event of changes in temperature, the length of the guide rails changes, and that the brickwork of the shaft may contract over time. Therefore, longitudinal adjustment is permitted between the guide rails and the brickwork of the shaft. The proposed fastening apparatus sufficiently holds the guide rails in the horizontal direction, and does not tightly clamp said rail in the vertical direction. For this purpose, a rail clamp is arranged on either side of the guide rail. A rail clamp consists of two circular disks of different diameters that lie coaxially on top of one another and transition into one another in a conical manner. In order to set the play, a plurality of spacer disks are inserted between the support plate and the rail clamp.

In the fastening apparatus known from CH-PS 484 826, it is necessary for it to be assembled from a plurality of parts, with the technician having to set the play by means of spacer disks.

U.S. Pat. No. 3,982,692 discloses fastening means that are used to fasten the faces of an elevator rail having a T-shaped profile to a support, this taking place such that a relative movement of the elevator rail is possible, for example in order to compensate for the building settling. Here, lateral movements are prevented, while limited movement of the elevator rail away from the support against the preload force of a spring tab is made possible.

The fastening known from U.S. Pat. No. 3,982,692 has the drawback that the adjusting movements, which are limited, but possible, allow torsion of the elevator rail along its longitudinal axis, and this results in corresponding curvature of the guide tracks provided on the elevator rail when, for example, transverse forces are transmitted from the elevator car or the counterweight to the elevator rail during operation. This is generally undesired.

EP 0 448 839 A1 discloses a fastening apparatus for the guide rails of elevators. In the known fastening apparatus, a change to a preload force of the rail clamps can be achieved by a semi-circular profile that is used as lining for the guide rail having different thicknesses. To do this, it is however necessary to determine which semi-circular profile is required and needs to be delivered before the elevator system is installed.

In an elevator system installed in a building, the elevator rails can be fastened to a building wall directly or indirectly. The elevator rails, used for example as guide rails for the elevator car or counterweight, may extend over the entire travel path of the elevator in this case, which often approximately corresponds to the height of the building. In this case, the elevator rails need to be fastened securely enough within the building that they can reliably absorb guide forces. The height of the building may change over time, however. The building shrinks because it dries out and settles, for example. The temperatures of the building and solar radiation may also cause the height of the building to change. The elevator rails can thus move relative to the building, it in particular being possible for the height of the building to reduce relative to the elevator rails. In order to prevent deformation to rail portions in this case, fastening points on the elevator rails are designed such that length compensation is made possible, but at the same time such that there is sufficient fastening to absorb guide forces.

### SUMMARY

One problem addressed by the invention is to provide a fastening device for an elevator rail, an elevator system comprising a plurality of fastening devices, and a method for fastening an elevator rail which all have an improved configuration. Specifically, one problem addressed by the invention is to provide a fastening device for an elevator rail, an elevator system comprising a plurality of fastening devices, and a method for fastening an elevator rail which allow improved fastening, which makes it possible for the elevator rail to carry out a relative movement along the extension thereof and also prevents movement or rotation in an imaginary plane perpendicular to the extension.

Solutions and proposals for a corresponding fastening device, a corresponding elevator system, and a corresponding method are hereinafter presented that solve at least parts of at least one of the objects. In addition, advantageous additional or alternative developments and embodiments are specified.

In one solution, the fastening device, which is used to fasten one face of a rail foot of an elevator rail relative to a fastening plane, may be designed to have a support region and a contact region, between which the face of the rail foot can be arranged, a compensation means being provided which has a first element and a second element, which can be moved relative to each other in an adjustment direction used to fasten the face of the rail foot of the elevator rail. In this case, the first element and the second element are designed such that, between the contact region and the support region, a holding dimension, viewed perpendicularly to the adjustment direction, in which a zero-backlash fastening of one face of a rail foot is enabled between the contact region and the support region, can be modified by a movement of the first element relative to the second element occurring in the adjustment direction.

The contact region faces a lower side of the rail foot and the support region faces a top side of the rail foot. Preferably, the support region is formed on the first element. Alternatively or additionally, the support region is formed on at least one protrusion formed on the first element. This is advantageous in that the rail foot can be positioned in the adjustment direction by means of the second element of the compensation means. A stop is preferably provided in the second element in this case. By adjusting the first element of the compensation means relative to the second element in the adjustment direction, the holding dimension can be easily adapted to the relevant dimensions of the rail foot or to the tolerance-related deviations of the rail foot.

The elevator rail is not part of the fastening device in this case. In particular, the fastening device can therefore also be produced and distributed independently of an elevator rail or of other components of an elevator system. During assembly of the elevator system, during which a plurality of elevator rails are generally assembled, a plurality of fastening devices of this type can be used in order to connect the elevator rails to a supporting structure connected to a shaft wall in an elevator shaft, for example. The fastening plane is then stationary relative to the shaft wall or the supporting structure. When assembling a plurality of fastening devices, they do not necessarily have the same fastening plane. Furthermore, it is also conceivable to sometimes use other fastening options for the elevator rails when fastening the elevator rails, if this is expedient. This means that a combination of conventional fastening options are possible using the proposed fastening devices. When mounting the fastening plane in the elevator system, it is usually oriented such that the elevator rails held on the fastening plane follow a vertical orientation. A pair of opposing fastening devices together form a fastening pair. Together, they hold the elevator rail in position. The pair of opposing fastening devices is generally arranged in the same fastening plane. The two opposing fastening devices may be of the same type, but may also be of different types.

Advantageously, the fastening device allows for adaptation to the relevant elevator rail that has just been mounted. Specifically, an adaptation to a thickness of the rail foot and/or a surface of the rail foot of a particular elevator rail that is fastened by the relevant fastening device is possible. With regard to a particular elevator rail, a particular holding dimension is then accordingly produced, with the fastening device allowing adjustment to this particular holding dimension.

If the fastening device is thus used to fasten a particular face of a rail foot of a particular elevator rail relative to a fastening plane, the fastening device then advantageously has a support region and a contact region, between which the face of the rail foot can be arranged. For this purpose, a compensation means is provided, the compensation means having a first element and a second element, which can be moved relative to each other in an adjustment direction used to fasten the face of the rail foot of the elevator rail. The first element and the second element are designed such that, between the contact region and the support region, the holding dimension, viewed perpendicularly to the adjustment direction, in which a zero-backlash fastening of the particular face of the rail foot of the particular elevator rail is enabled between the contact region and the support region, can be modified by a movement of the first element relative to the second element occurring in the adjustment direction.

In a preferred solution, at least one first sliding surface that has a constant or variable inclination relative to the adjustment direction is formed on the first element. Additionally or alternatively, at least one second sliding surface that has a constant or variable inclination relative to the adjustment direction is formed on the second element. It is also advantageous here for the sliding surfaces formed on the elements to face one another. The inclination of the second sliding surface advantageously corresponds to the inclination of the first sliding surface in this case. Here, the first sliding surface and the second sliding surface interact to set the holding dimension. The holding dimension can thus be precisely set according to a local dimension of the rail foot. The first and second element may be substantially rigid, i.e. inflexible. Since the rail foot is held without backlash to such an extent, it can be moved in the longitudinal direction, and lateral tilting or movement can be prevented at the same time.

Specifically, it is advantageous that a sliding surface of this type is formed on a wedge-shaped part of the corresponding element. Alternatively, it is possible for the sliding surface to be formed on a bent part of this element. Optionally, one element may be of one type and the other element may be of the other type.

Depending on the design of the first element and the second element of the compensation means, it is also possible for just one of the elements to have a sliding surface that is not inclined and is planar relative to the adjustment direction, but for the other element to have an inclined sliding surface. In this way, it is possible to set the required holding dimension in an improved manner by moving the two elements relative to one another.

Another possible solution consists in an elevator system comprising at least one assembly of elevator rails arranged in succession along a longitudinal axis and a plurality of fastening devices each designed in a proposed manner, the fastening devices each being assigned to the faces of the rail feet of the elevator rails, and each of these fastening devices making it possible to set the holding dimension required on the assigned face of the rail foot of the assigned elevator rail. The elevator rails arranged in succession in the longitudinal direction thereof, which can also be referred to as elevator rail portions, then form an assembly extending substantially over the entire height of the elevator shaft on the braking tracks and/or guide tracks. An assembly of this type can also be referred to as an elevator car guide rail or counterweight guide rail in its entirety. Generally, a plurality of assemblies of this type are provided in order to form an appropriate number of braking tracks and/or guide tracks for the elevator car and the counterweight which may be provided. Here, each individual elevator rail can be mounted on each of the faces thereof by a particular number of fastening devices. This is particularly advantageous in that no preparatory measures are required to adapt to differences between the elevator rails, which are for example caused by manufacturing. The holding dimension that is required in each case can specifically be directly set by the movement of the first element relative to the second element, which takes place in the adjustment direction, when mounting the relevant elevator rail in its mounting position.

One proposed solution also consists in a method for fastening a rail foot of an elevator rail, carried out using at least one fastening device designed in a proposed manner, the fastening device being mounted relative to a fastening plane and the rail foot being fastened relative to the fastening plane by the movement of the first element relative to the second element, which takes place in the adjustment direction. Corresponding advantages result here.

Specifically in the method and for a preferred mode of assembly, it is advantageous for a first fastening device to be mounted on the rail foot on a first face of the rail foot and for a second fastening device to be mounted on said rail foot on a second face of the rail foot so as to be opposite one another such that the first fastening device and the second fastening device fasten the rail foot in the adjustment direction but allow movement of the rail foot along a longitudinal axis of the elevator rail. Accordingly, particularly in an elevator system, the plurality of fastening devices may be mounted in pairs on a first face of the rail foot and on a second face of the rail foot so as to be opposite one another. Depending on the particular application, however, other mounting options are also possible. In principle, it is also possible for the proposed fastening devices to be provided on just one face of the rail foot, while another type of fastening can be produced on the other side, for example. Another type of fastening may for example consist in a rigid fastening clamp that is suitably screwed on and does not comprise any elements that can be adjusted relative to one another.

It is advantageous for the first element and the second element to be designed such that the holding dimension, in which a zero-backlash fastening of one face of a rail foot is enabled between the contact region and the support region, can be continuously reduced by the movement of the first element relative to the second element occurring in the adjustment direction until the face of the rail foot of the elevator rail is fastened between the contact region and the support region without backlash. In principle, it is possible to adapt the holding dimension to any face of a rail foot of any elevator rail. When the specific elevator rail intended to be mounted by the fastening device is determined, the holding dimension is set by the holding dimension being able to be continuously reduced by the movement of the first element relative to the second element occurring in the adjustment direction until the selected face of the rail foot of the specified elevator rail is fastened between the contact region and the support region without backlash. As a result, an adaptation to variations in the thickness of the rail foot caused by manufacturing is possible in particular. When fastened, the elevator rail is then in particular reliably prevented from twisting in the longitudinal direction thereof. Movements of the elevator rail in a plane that is perpendicular to the longitudinal direction of the elevator rail can also be effectively restricted. “Fastened without backlash” means that the transverse position of the rail foot is defined and that the rail foot can, however, move along a longitudinal axis of the elevator rail if there is a relative change in length between the building and the elevator rail. The fastening takes place here using a first fastening device of this type on a first face of the rail foot and using a second fastening device on a second face of the rail foot, such that they are mounted on the rail foot so as to be opposite one another. The second fastening device may preferably be of the same type here, but may also be of different types.

Preferably, the second elements of the opposing fastening devices each comprise a stop. By means of these stops on either side, the entirety of the rail foot is positioned in the adjustment direction. This positioning is carried out such that the rail foot is held in the adjustment direction without backlash.

It is also advantageous for the second element for fastening the face of the rail foot relative to the adjustment direction to be held in an at least substantially stationary manner relative to the fastening plane when the first element for fastening the face of the rail foot relative to the second element is moved in the adjustment direction.

In an alternative, the contact region is formed on the first element. It is also advantageous for the contact region to be formed on a protrusion formed on the first element. In particular if the contact region is formed on a protrusion, the contact with the rail foot may be at a defined point or on a defined surface. As a result, defined bearing or support is made possible. However, it is also possible for a plurality of protrusions to be provided in order to make the contact possible. It may be advantageous here for the first element to have a certain amount of resilience in order to produce contact with all the protrusions provided during assembly. Therefore, single-point or multiple-point contact with the first element can advantageously be produced. In so doing, direct contact between the rail foot and the contact region of the first element can be made possible in particular.

In a modified embodiment, it is also possible for an intermediate layer to be provided, which can be arranged between the rail foot and the first element in order to fasten the face of the rail foot. By means of an intermediate layer of this type, further adaptation to the particular application is possible. For example, the intermediate layer may comprise a sliding face facing the first element and/or a sliding face facing the rail foot. A sliding face facing the first element can in particular ensure optimal movability of the first element relative to the second element. As a result, the holding dimension is set independently of the surface finish or the material of the rail foot. Owing to the sliding face facing the rail foot, optimal movability of the elevator rail relative to the fastening device in the longitudinal direction of the elevator rail can also be achieved in order to compensate for changes in length between the elevator rail and the building that are temperature-related or are caused by the building settling.

In a variant, the compensation means of the fastening device can be arranged beside the support element so as to be offset along the longitudinal axis.

In a preferred solution, the support region may be formed on the first element or on a protrusion formed on the first element. In particular if the contact region is formed on a protrusion, the contact with the rail foot may be at a defined point or on a defined surface. As a result, defined bearing or support is made possible. However, it is also possible for a plurality of protrusions to be provided in order to make the contact possible. It may be advantageous here for the first element to have a certain amount of resilience in order to produce contact with all the protrusions provided during assembly. Therefore, single-point or multiple-point contact with the first element can advantageously be produced. In so doing, direct contact between the rail foot and the contact region of the first element, or the support region of the support element, can be made possible in particular. In a modified embodiment, it is also possible in this solution for an intermediate layer to be provided, which can be arranged between the rail foot and the first element in order to fasten the face of the rail foot. By means of an intermediate layer of this type, further adaptation to the particular application is possible. For example, the intermediate layer may comprise a sliding face facing the first element and/or a sliding face facing the rail foot. A sliding face facing the first element can in particular ensure optimal movability of the first element relative to the second element. By means of a sliding face facing the rail foot, optimal longitudinal movability of the elevator rail can also be achieved.

Furthermore, it is advantageous for at least one element to be designed as a sprung element. Therefore, a suitable embodiment can be selected in relation to the particular application. By means of the inclination, a movement in the adjustment direction is converted into a reduction in the holding dimension. Depending on the embodiment, the correlation of the reduction in the holding dimension may be progressive, degressive or linear depending on the adjustment in the adjustment direction. For example, a degressive correlation allows a rapid reduction in the holding dimension at the start, and fine adjustment at the end. This is suitable for applications in which a large amount of backlash is initially provided for assembly. Depending on the particular application, however, other correlations can also be modeled.

In the embodiment of the fastening device, it is possible for an additional support element to be provided. Advantageously, the support region is formed on a support element of this type. However, embodiments without a separate support element are also conceivable. An embodiment including a support element has the advantage that further assembly options are opened up. It is thus conceivable, for example, that, by means of the support element or support region and/or a stop, an assembly position is defined on the support element which allows improved orientation of a plurality of elevator rails that are arranged together.

It is also advantageous here for the support element to comprise a through-opening or a groove that extends through the support element in the adjustment direction, and for at least the first element to be able to extend through the through-opening or the groove in the support element in order to fasten the face of the rail foot. This allows both a compact design in which a certain amount of guidance or protection against loss can be provided for the two elements, and also mechanical protection of the elements of the compensation means can be provided in this embodiment. This is advantageous for the assembly of the elevator rails, inter alia.

It is also advantageous for the second element to be connected to a base plate defining the fastening plane in order to fasten the face of the rail foot below or beside the support element, or for the second element to contact a base plate in order to fasten the face of the rail foot or for the second element to be integrated in a base plate. When integrating the second element in a base plate, a recess or opening can be made in the base plate which, with or without an inclination, allows the first element to be lifted to reduce the holding dimension when the first element is gradually drawn out of the recess during adjustment in the adjustment direction.

### DESCRIPTION OF THE DRAWINGS

Preferred embodiments of the invention shall be described in greater detail in the following description with reference to the accompanying drawings, in which:

FIG. 1 is a schematic, three-dimensional view of a fastening device according to a first embodiment of the invention;

FIG. 2 shows an elevator rail fastened to a supporting structure by means of fastening devices according to the first embodiment;

FIG. 3 shows a detail, denoted III in FIG. 2, while the elevator rail is being mounted;

FIG. 4 shows a detail, denoted III in FIG. 2, when the elevator rail is mounted;

FIG. 5 shows an intermediate layer for a fastening device according to a second embodiment of the invention;

FIG. 6 shows the fastening device according to the second embodiment of the invention, which is used to fasten a face of a rail foot of an elevator rail;

FIG. 7 is a three-dimensional view of fastening devices according to a third embodiment, of which one is shown in part, and a supporting structure;

FIG. 8 is a three-dimensional exploded view of a fastening device according to a fourth embodiment of the invention;

FIG. 9 shows an elevator rail fastened to a supporting structure by means of fastening devices according to the fourth embodiment;

FIG. 10 is a partial schematic view of an elevator system according to a possible embodiment of the invention; and

FIG. 11 shows a detail, denoted XIII in FIG. 10, of an assembly of elevator rails to explain a possible embodiment of the invention.

Throughout the figures, the reference numerals are identical for identically operating parts.

### DETAILED DESCRIPTION

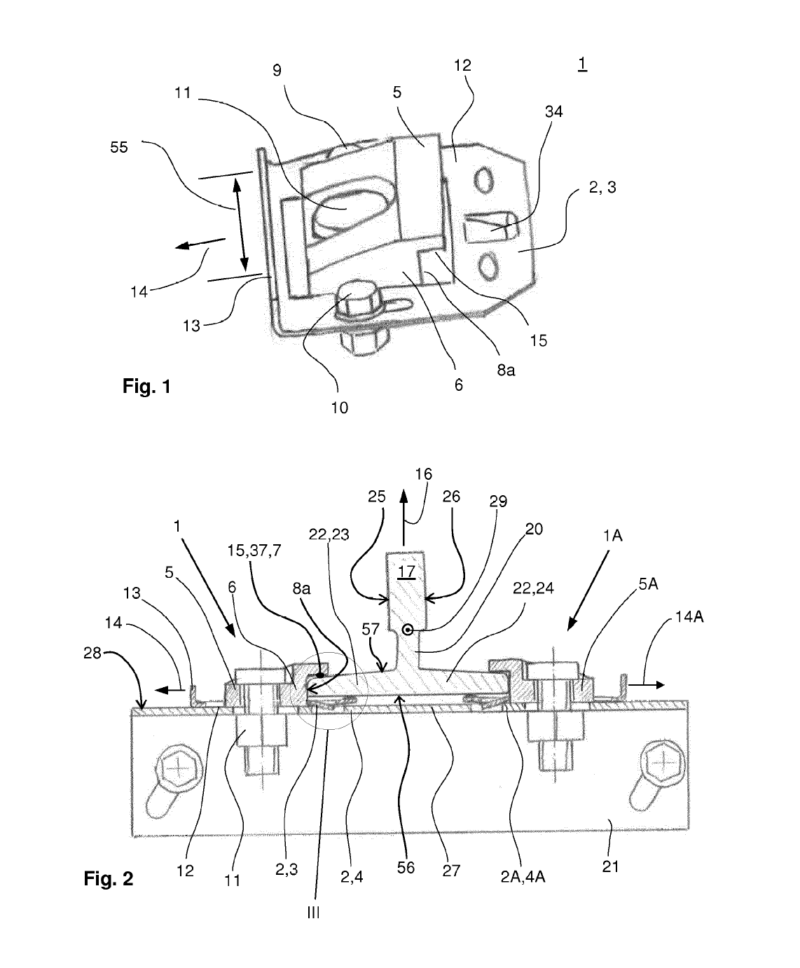

FIG. 1 is a schematic, three-dimensional view of a fastening device 1 according to a first embodiment. The fastening device 1 comprises a compensation means 2, FIG. 1 showing a first element 3 of the compensation means 2. The compensation means 2 also comprises a second element 4 (FIG. 2).

The fastening device 1 in the first embodiment also comprises a support element 5 that comprises a jaw 6, on which a surface 15 and a stop 8a are formed. The surface 15 and the stop 8a are each planar and are oriented at least approximately perpendicularly to one another. A support region 7 (FIG. 2) is formed on a protrusion 37 of the surface 15. In a modified embodiment, the support region 7 on the jaw 6 of the support element 5 can also be formed in a different manner, in particular directly by a planar support surface 15 formed by the surface 15. The fastening device 1 also comprises fastening means 9, 10, 11.

The first element 3 of the compensation means 2 comprises a part 12 and a tension plate 13. Here, the tension plate 13 is bent by 90° relative to the part 12. If the support element 5 is fastened so as to be stationary by the fastening means 11, the first element 3 can be adjusted on the tension plate 13 in an adjustment direction 14 by a technician. As an alternative to the tension plate 13, an opening can also be provided in the first element 3 that can for example be used to position a screwdriver, in order to adjust the first element 3 in the adjustment direction 14.

FIG. 2 is a partial schematic view of an elevator rail 20 fastened to a supporting structure 21 by means of fastening devices 1, 1A according to the first embodiment. The elevator rail 20 comprises a rail foot 22 that has a rail head 17, a first face 23 and a second face 24. In addition, tracks 25, 26 are formed on the elevator rail 20 that are used as braking tracks and/or guide tracks 25, 26. The fastening device 1 is used to fasten the first face 23 of the rail foot 22 to the supporting structure 21. The fastening device 1A is designed to correspond to the fastening device 1, it being used to fasten the second face 24 of the rail foot 22 to the supporting structure 21. The fastening devices 1, 1A are mounted on the rail foot 22 so as to face one another. Said devices fasten the rail foot 22 owing to their joint effect. The assembly is carried out here such that the rail foot 22 is prevented from moving in the adjustment direction 14 by the stop 8a of the support element 5 of the fastening device 1. The same applies to the fastening device 1A and to the adjustment direction 14A specified for the fastening device 1A. As a result, the rail foot 22 is prevented from moving on either side in the adjustment direction 14 or the adjustment direction 14A.

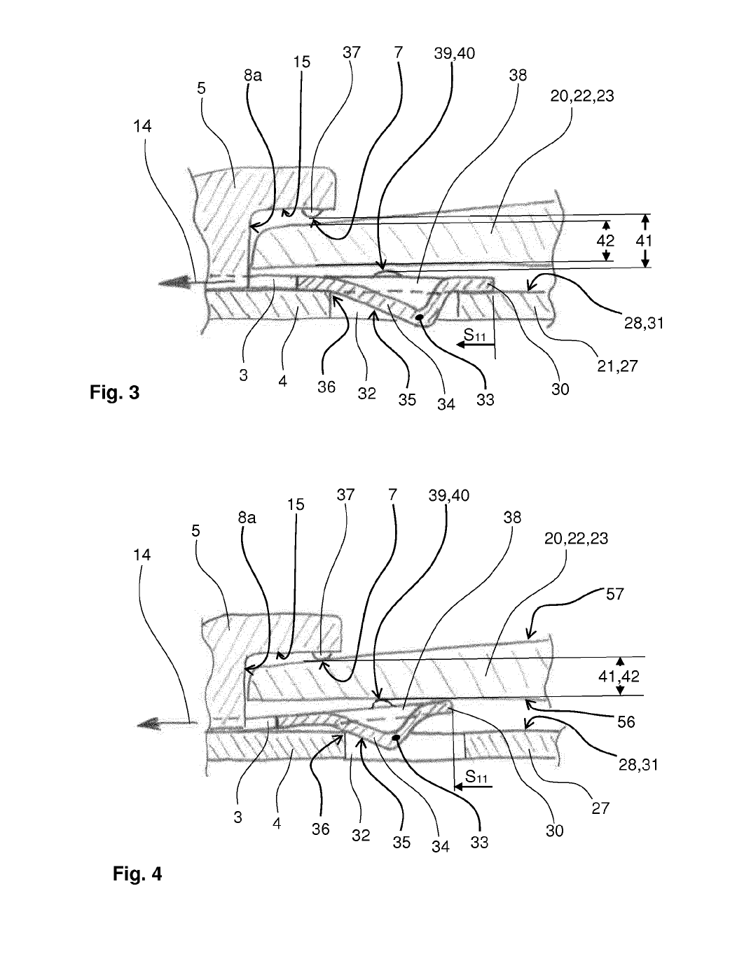

In this embodiment, a base plate 27 is provided. The base plate 27 forms a fastening plane 28. Here, the base plate 27 is connected to the supporting structure 21 in a suitable manner or it forms a cohesive part, for example a fastening bracket, together with the supporting structure. The second element 4 of the compensation means 2 of the fastening device 1 and a second element 4A of a compensation means 2A of the fastening device 1A are integrated in the base plate 27 in this embodiment. A type of fastening and a method for fastening the rail foot 22 of the elevator rail 20 according to the first embodiment are described in greater detail in the following on the basis of FIGS. 3 and 4.

The assembly is carried out here such that the fastening devices 1, 1A together with the rail foot provide fastening in the adjustment direction 14, 14A and in a guide direction 16 transverse to the adjustment direction 14, 14A, but allow movement of the rail foot 22 along a longitudinal axis 29 of the elevator rail 20. As a result, when a building settles or in the event of temperature-related relative changes in length, it is made possible for the rail foot 22 to move relative to the fastening plane 28.

FIG. 3 shows a detail, denoted III in FIG. 2, of the fastening device 1 while the elevator rail 20 is being mounted. FIG. 4 shows a detail, denoted III in FIG. 2, when the elevator rail is mounted. The fastening to the first face 23 of the rail foot 22 is described with reference to FIGS. 3 and 4. The fastening to the second face 24 of the rail foot 22 is carried out in a corresponding manner.

FIG. 3 shows the first element 3 in an initial state determined for the assembly. One end 30 of the first element 3, which is remote from the tension plate 13, rests on a top side 31 of the base plate 27. The second element 4, which is integrated in the base plate 27, comprises a cut-out 32, which is formed as a through-opening 32 in this embodiment. A bent part 33 is positioned in the cut-out 32 in the second element 4 in the initial position. A wedge-shaped part 34 is formed on the bent part 33 in this case, the wedge-shaped part 34 having a sliding surface 35. The sliding surface 35 is assigned to an edge 36 of the second element 4 here. In this case, a rounded or beveled edge 36 may be provided here in order to make it easier to adjust the first element 3 in the adjustment direction 14.

In a modified embodiment, an inclined surface, in particular a sliding surface, which is assigned to the sliding surface 35 of the first element 3, may also be provided on the second element 4 instead of the edge 36. Furthermore, in a modified embodiment, it is possible for the cut-out 32 not to be designed as a through-opening 32, but as a recess 32 in the second element 4.

During assembly, the support element 5 is fastened to the supporting structure 21, the first face 23 of the rail foot 22 being positioned in part between the jaws 6 of the support element 5 and the first element 3 that is resting on the base plate 27. Here, the support element 5 is mounted so as to be stationary relative to the fastening plane, the rail foot 22 being prevented from moving in the adjustment direction 14 due to the contact with the rail foot 22. In this case, the support element 5 can be adjusted and fixed in position such that the rail foot 22 is fixed in the adjustment direction 14 by means of the stop 8a.

In a possible embodiment shown in FIGS. 3 and 4, the support region 7 is formed on the protrusion 37 of the jaws 6 that projects from the surface 15. Furthermore, a protrusion 39 on which a contact region 40 is formed is formed on a part 38 of the first element 3. A holding dimension 41 that is initially greater than the required holding dimension 42 is produced between the support region 7 and the contact region 40. The required holding dimension 42 is determined by the geometry of the rail foot 22 here. Owing to manufacturing-related tolerances, different holding dimensions 42 generally result for different elevator rails 20, 20A (FIG. 11) or for different foot regions of the elevator rails 20, 20A.

Once the support element 5 is mounted and fixed in position, the first element 3 is adjusted in the adjustment direction 14 until the situation shown in FIG. 4 is reached, in which the holding dimension 41 between the support region 7 and the contact region 40 is equal to the required holding dimension 42 determined by the geometry of the rail foot 22. In the adjusted position, as shown in FIG. 4, the first element 3 presses the rail foot 22 against the jaws 6 of the support element 5. By designing the first element 3 to comprise the bent part 33, the first element 3 may be designed as a sprung element 3. A possible preload force is however limited such that the desired movement of the rail foot 22 is made possible along the longitudinal axis 29 of the elevator rail 20. Alternatively, the first element 3 comprising the bent part 33 is designed as a substantially inflexible component. This means that the holding dimension 41 can be adapted to the geometry of the rail foot 22 precisely and without force. A longitudinal movement of the rail foot 22 relative to the fastening plane 28 is thus made possible in an almost entirely unimpeded manner.

In addition, the support region 7 and the contact region 40, as well as the stop 8a if necessary, may be provided with sliding coatings in order to make it easier for the rail foot 22 to move longitudinally or to reduce a corresponding penetration force.

In order to reduce the holding dimension 41 existing in the initial state, as shown in FIG. 3, to the required holding dimension 42, a movement S₁₁ is required in this embodiment. The first element 3 is actuated by this movement S₁₁ in the adjustment direction 14 in order to achieve the fastening. In this case, the first element 3 slides along the edge 36 on its sliding surface 35 formed on the wedge-shaped part 34 until the end position shown in FIG. 4 is reached. Once the holding dimension 41 has been set, the first element 3 is fixed in this position for example by means of the fastening means 9, 10 shown in FIG. 1.

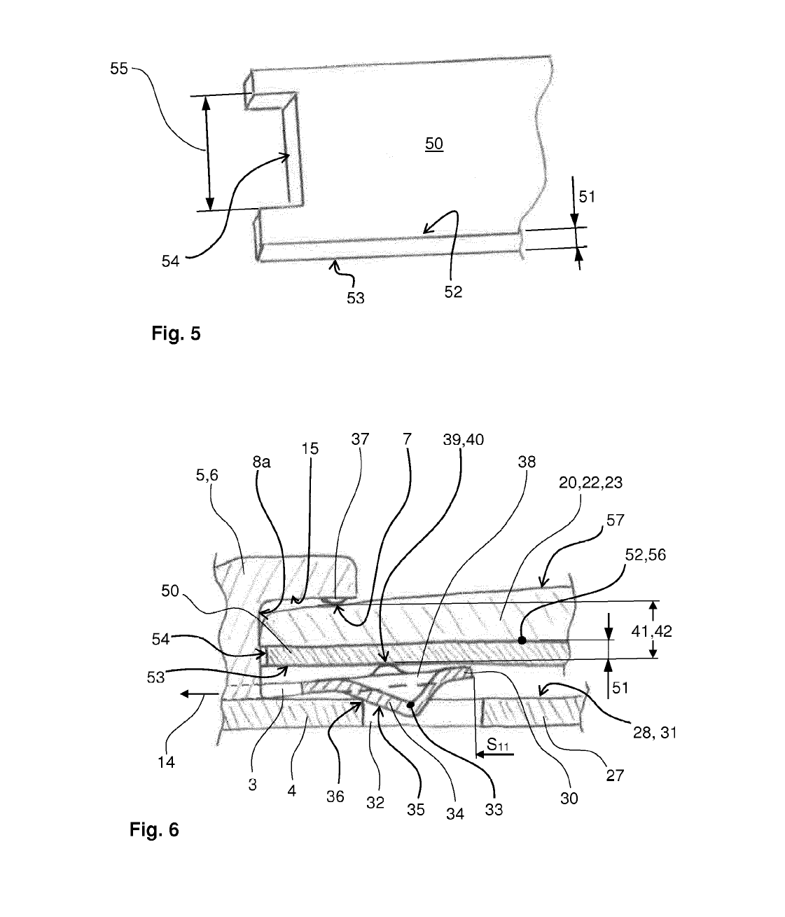

FIG. 5 is a schematic, three-dimensional view of a possible intermediate layer 50 for a fastening device 1 according to a second embodiment. The intermediate layer 50 preferably has a constant thickness 51. Furthermore, the intermediate layer 50 may be designed as a sliding face 52, 53 on its top side 52 and/or its lower side 53. Here, it is possible to form the intermediate layer 50 or provide a coating on the top side 52 and/or lower side 53 using Teflon (registered trademark of The Chemours Company) or other sliding coatings. In addition, a face of the intermediate layer 50 facing the rail foot 22 may be curved (not shown); as a result, warping of the rail fastening is prevented when the fastening plane 28 is slightly slanted.

In this embodiment, the intermediate layer 50 comprises an assembly groove 54, which is designed such that the jaws 6 can be inserted into the assembly groove 54 at least in part. A dimension 55 of the assembly groove is produced here from a corresponding dimension 55 of the jaws 6 of the support element 5, which is shown in FIG. 1. As a result, in the assembled state as shown in FIG. 6, the assembly groove 54 is received by the jaws 6 with as little backlash as possible relative to the longitudinal axis 29. The intermediate layer 50 thus remains substantially stationary relative to the fastening device 1, and there is a potential sliding movement between the lower side 56 of the rail foot 22 and the top side 52 of the intermediate layer 50. In a detailed design, the intermediate layer 50 may be symmetrical such that the top side 52 and the lower side 53 can be swapped. This prevents any potential incorrect assembly.

FIG. 6 shows the fastening device 1 according to the second embodiment, which is used to fasten the first face 23 of the rail foot 22 of the elevator rail 20. In this embodiment, the jaws 6 are designed to be accordingly adapted such that the additional thickness 51 of the intermediate layer 50 is taken into account. In this embodiment, the protrusion 39 of the first element 3 rests on the lower side 53 of the intermediate layer 50 in the assembled state. Furthermore, the top side 52 of the intermediate layer 50 rests on a lower side 56 of the rail foot 22. The protrusion 37 of the jaws 6 of the support element 5 rests on a top side 57 of the rail foot 22.

In the first embodiment, shown in FIGS. 3 and 4 inter alia, the top side 57 of the rail foot 22 rests directly on the support region 7 of the support element 5. Furthermore, the lower side 56 of the rail foot 22 rests directly on the contact region 40 of the first element 3 of the compensation means 2.

In the embodiment described with reference to FIGS. 5 and 6, however, the rail foot 22 rests on the contact region 40 of the protrusion 39 of the first element 3 of the compensation means 2 by means of the intermediate layer 50. For example in the event of a relative change in length of the elevator rail 20 along its longitudinal axis 29, caused by the building settling, the lower side 56 of the rail foot 22 slides along the top side 52 of the intermediate layer 50. The sliding friction occurring as a result and also initial static friction can be reduced by designing the top side 52 as a sliding face 52. In a modified embodiment, it is also possible, additionally or alternatively, for there to be indirect contact between the top side 57 of the rail foot 22 and the support region 7 of the support element 5. Furthermore, an adjustment of the first element 3 or the contact with the contact region 40 of the first element 3 can be improved by the intermediate layer 50. Specifically, by designing the lower side 53 of the intermediate layer 50 as a sliding face 53, the friction relative to the first element 3 can be reduced. In addition, the intermediate layer 50 prevents the position of the first element 3 being changed due to forces acting along the longitudinal axis 29 during a relative movement of the rail foot 22 towards the fastening device 1, since there is no relative movement between the protrusion 39 and the lower side 53 of the intermediate layer 50.

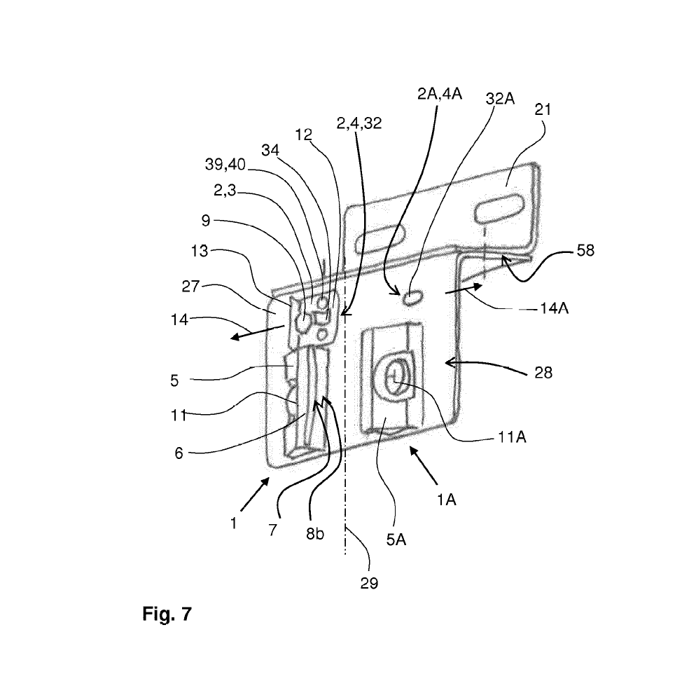

FIG. 7 is a three-dimensional view of fastening devices 1, 1A according to a third embodiment and of a supporting structure 21, the fastening device 1A being shown in part. The fastening device 1 comprises the support element 5 that is screwed to the base plate 27. Furthermore, the fastening device 1 comprises a first element 3 arranged beside the support element 5 so as to be offset along the longitudinal axis 29 and a second element 4 integrated in the base plate 27. Accordingly, the fastening device 1A comprises the support element 5A and the second element 4A integrated in the base plate 27. The first element of the fastening device 1A is not shown.

A wedge-shaped part 34 is formed on the first element 3, which part is adjusted relative to the second element 4 or the base plate 27 when the first element 3 is adjusted in the adjustment direction 14. As a result, the holding dimension 41 is set as previously explained, by, when the first element 3 is being adjusted in the adjustment direction 14, the wedge-shaped part 34 being adjusted over the cut-out 32 made in the base plate 27 until the holding dimension 41 corresponds to the required holding dimension 42. In its final position, the first element 3 is fixed in position relative to the second element 4 by the fastening means 9. In this way, the first face 23 of the rail foot 22 can be pressed against the support region 7 of the support element 5 in order to fasten the first face 23 of the rail foot 22. Accordingly, the second face 24 of the rail foot 22 is fastened by the fastening device 1A.

The base plate 27 is bent in an L shape and is screwed to the supporting structure 21 by one face 58. The fastening plane 28 is located on the base plate 27. The fastening plane 28 is characterized in that it is stationary relative to the supporting structure 21. The fastening means 9, 11, 11A allow the support elements 5, 5A and the first elements 3 of the compensation means 2, 2A to be fastened or fixed in position relative to the fastening plane 28 in a stationary manner, the first element of the compensation means 2A not being shown. Arranging the fastening plane 28 so as to be stationary relative to the supporting structure 21 means that the base plate 27 can be adjusted together with the fastening plane 28 relative to the supporting structure 21 such that any inaccuracies in the building can be equaled out during assembly by orienting the base plate 27. After adjustment, the base plate 27 is for example screwed to the supporting structure 21, such that the fastening plane 28 is stationary relative to the supporting structure 21.

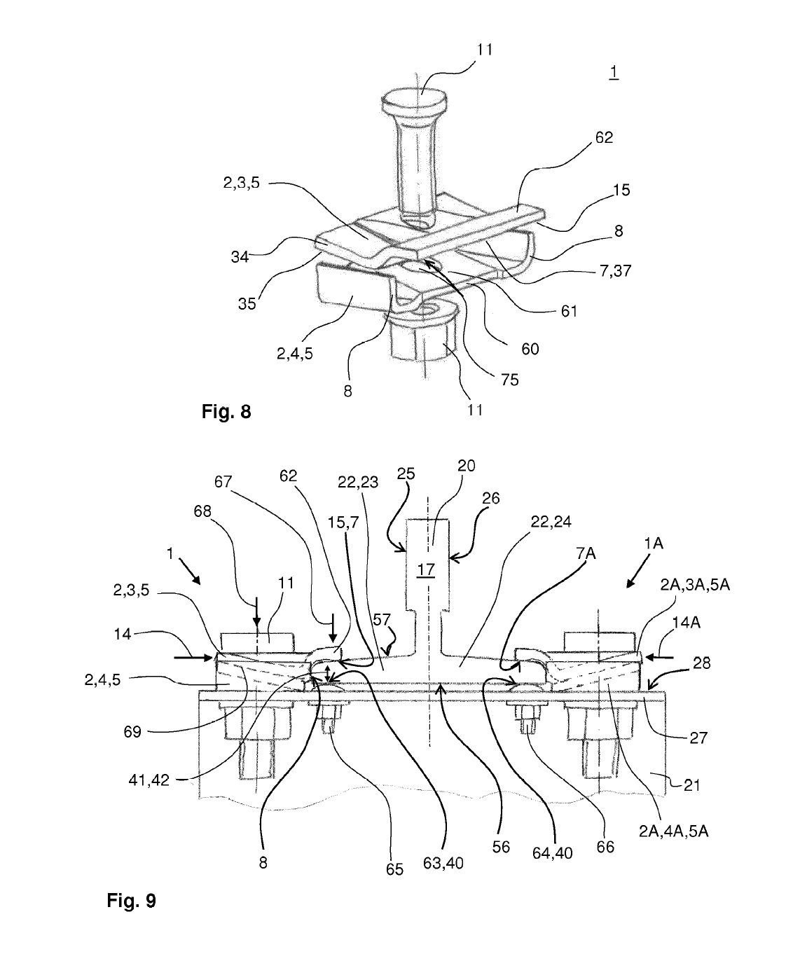

FIG. 8 is a three-dimensional exploded view of a fastening device 1 according to a fourth embodiment. In this embodiment, the support element 5 itself is designed as a compensation means 2. In this case, a stop 8 is formed on the second element 4 of the compensation means 2. By positioning the second element 4 and corresponding stop 8, the rail foot is positioned in the adjustment direction 14.

Here, the first element 3 is inserted into the second element 4 at least in part, a wedge-shaped part 34 of the first element 3 being in contact with a wedge-shaped part 60 of the second element 4. The contact is preferably made here on inclined surfaces 35, 61, which are formed as first and second sliding surfaces 35, 61.

Furthermore, a protrusion 62, in particular a cuboid or lip-shaped protrusion 62, is formed on the first element 3, the support region 7 being formed on a protrusion 37 provided on the protrusion 62. The protrusion 37, which is hidden from view in FIG. 8, may for example be designed so as to correspond to the protrusion 37 shown in FIG. 3. The support region may be formed in a modified embodiment in which a protrusion 37 of this type is not provided, but may also be in the form of a support surface 15 formed on the protrusion 62. Furthermore, a fastening means 11 is provided, which may be formed by a bolt and a nut. A lead-through in the first element 3 leading to the lead-through in the fastening means 11 is designed as a slot, such that the first element 3 can move relative to the second element 4. The slot or through-opening 75 may also be provided in the second element 4.

The fastening of the elevator rail 20 by means of fastening devices 1, 1A according to the fourth embodiment shown in FIG. 8 is also described in greater detail in the following with reference to FIG. 9.

FIG. 9 shows the elevator rail 20, which is fastened to a fastening plane 28 or to a supporting structure 21 by means of fastening devices 1, 1A. For assembly, the rail foot 22 is supported on rounded heads 63, 64 of screw elements 65, 66. If necessary, commercially available screws with round heads can be used. The rounded heads 63, 64 of the screw elements 65, 66 define the contact region 40. Here, direct contact is provided between the lower side of the rail foot 56 and the contact region 40. In a modified embodiment, however, indirect contact may also be provided, the intermediate layer 50 shown in FIG. 5 being able to make contact in an accordingly modified manner, for example.

The compensation means 2 and simultaneously the support element 5 are produced by means of the first and second element 3, 4, and, as previously mentioned, by positioning the second element 4 and corresponding stop 8a, the rail foot can be positioned in the adjustment direction 14. Corresponding slots are made in the base plate 27. By moving the first element 3 in the adjustment direction 14 relative to the second element 4, the protrusion 62 can be lowered together with the support region 7, as shown by an arrow 67. As a result, the holding dimension 41 is reduced to the required holding dimension 42. The fastening means 11 is then tightened, as shown by an arrow 68, such that the two elements 3, 4 of the compensation means 2 are fixed in position relative to one another and relative to the fastening plane 28. Depending on the design of the fastening device 1, an intermediate part 69 may also be provided in order to increase a possible holding dimension 41. The first sliding surface 35 and the second sliding surface 61 may be roughened if required, in order to prevent unintended adjustment during subsequent operation.

The fastening to the second face 24 of the rail foot 22 is carried out in a corresponding manner by means of the fastening device 1A.

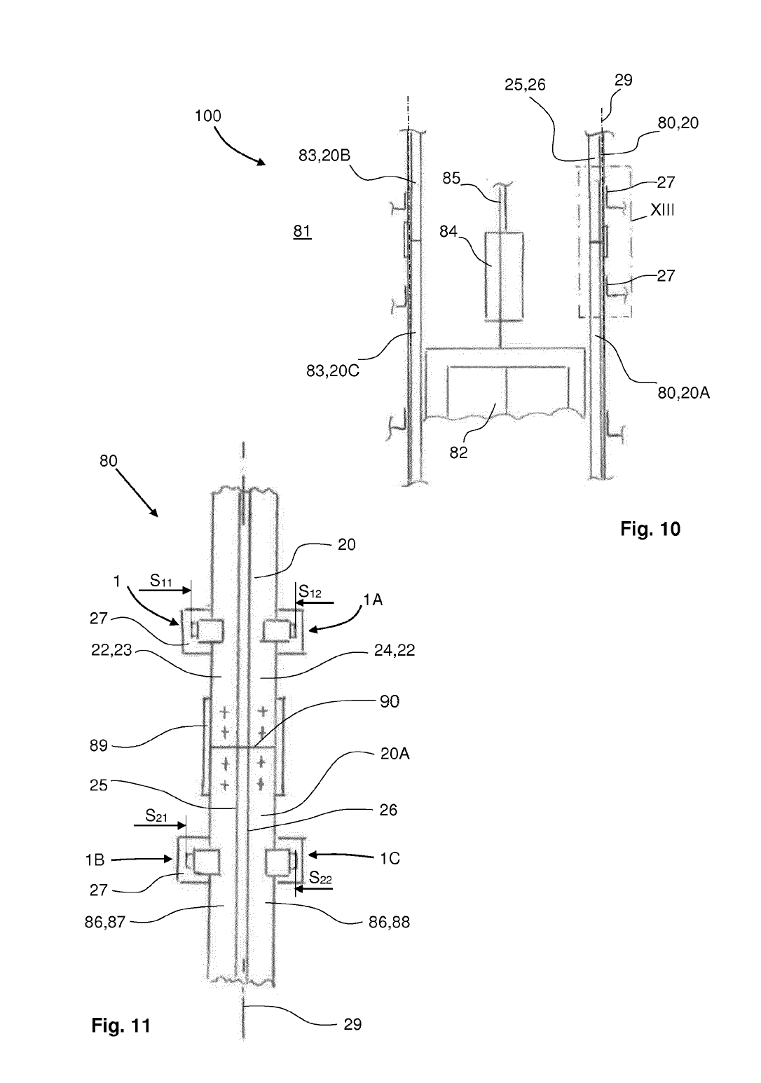

FIG. 10 is a partial schematic view of an elevator system 100 according to a possible embodiment of the invention. The elevator system 100 comprises a plurality of elevator rails 20, 20A, 20B, 20C. Here, the elevator rails 20, 20A are part of an assembly 80 of a plurality of elevator rails 20, 20A that extend through the elevator shaft 81, along a longitudinal axis 29. As a result, tracks 25, 26 are formed that are used as braking tracks and/or guide tracks 25, 26 for an elevator car 82. Accordingly, other assemblies of elevator rails may be provided. By way of example, another assembly 83 comprising the elevator rails 20B, 20C is shown which is also used for the elevator car 82. Other assemblies of elevator rails of this type can be provided for a counterweight 84. Here, the counterweight 84 is connected to the elevator car 82 by a support means 85.

FIG. 11 shows a detail, denoted XIII in FIG. 10, of the assembly 80 of elevator rails 20, 20A to explain a possible embodiment of the invention. In this case, the assembly 80 consists of a plurality of elevator rails 20, 20A, of which only the elevator rails 20, 20A are shown in part. The elevator rails 20, 20A are arranged along a longitudinal axis 29 and adjoin one another at an interface 90. The elevator rails 20, 20A are joined together by means of connecting plates 89 at the interface 90. As a result, continuous tracks 25, 26 are formed on the assembly 80 of the elevator rails 20, 20A. The elevator rail 20 comprises the rail foot 22 comprising the first face 23 and the second face 24. Accordingly, the elevator rail 20A comprises a rail foot 86 that has a first face 87 and a second face 88. An appropriate number of fastening devices are used to fasten each of the elevator rails 20, 20A, fastening devices 1, 1A, 1B, 1C being schematically shown.

As shown by FIGS. 3 and 4, the movement S₁₁ allows the first face 23 of the rail foot 22 of the elevator rail 20 to be fastened by means of the fastening device 1. A movement S₁₂ is used to fasten the second face 24 of the elevator rail 20. The movement S₁₁ and the movement S₁₂ may be the same, but they also may be different. Accordingly, on the fastening device 1B, a movement S₂₁ is carried out to fasten the first face 87 of the rail foot 86. A movement S₂₂ is carried out on the fastening device 1C to fasten the second face 88 of the rail foot 86. Generally, the movement S₂₁ differs from the movement S₁₁ because there are for example manufacturing tolerances between the individual elevator rails 20, 20A which lead to different values for the required holding dimension 42 (FIG. 3). The assembly is nevertheless particularly simple, since the movement Sᵢⱼ (i, j=1, 2) required in each case during the adjustment of the first element 3 relative to the second element 4 in the adjustment direction 14 is set or produced when the relevant face 23, 24, 87, 88 of the rail foot 22, 86 of the relevant elevator rail 20, 20A is clamped.

The invention is not limited to the described embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. A fastening device for fastening a face of a rail foot of an elevator rail relative to a fastening plane, comprising
a support region and a contact region formed on the fastening device, wherein when the face of the rail foot is arranged between the support region and the contact region, the contact region faces a lower side of the rail foot and the support region faces a top side of the rail foot;
a compensation means having a first element and a second element, the first element and the second element being moveable relative to each other in an adjustment direction for fastening the face of the rail foot, the first element and the second element being formed such that, between the contact region and the support region, a holding dimension, viewed perpendicularly to the adjustment direction, in which a zero-backlash fastening of one side of a rail foot is enabled between the contact region and the support region, can be modified by a movement of the first element relative to the second element in the adjustment direction, and the support region being formed on the first element or on at least one protrusion formed on the first element; and
a first sliding surface that has a constant inclination relative to the adjustment direction is formed on the first element, and a second sliding surface that has a constant inclination relative to the adjustment direction is formed on the second element.

12. The fastening device according to claim 11 wherein at least one of the inclination of the second sliding surface corresponds to the inclination of the first sliding surface and the first sliding surface cooperates with the second sliding surface to set the holding dimension.

13. The fastening device according to claim 11 including a support element having the first element with the support region and the second element, at least one stop being formed on the second element.

14. The fastening device according to claim 13 wherein rail foot engages the stop to position the rail foot in the adjustment direction.

15. The fastening device according to claim 13 wherein the support element includes a through-opening or a groove that extends through the support element in the adjustment direction, and wherein the first element can be moved along the through-opening or the groove in the support element to fasten the face of the rail foot.

16. The fastening device according to claim 11 wherein the rail foot directly contacts at least one of the contact region and the support region when the face of the rail foot is arranged between the support region and the contact region.

17. The fastening device according to claim 11 including an intermediate layer arranged between the rail foot and the contact region or between the rail foot and the support region, the intermediate layer having at least one sliding face facing one of the contact region, the support region and the rail foot.

18. The fastening device according to claim 11 wherein the second element is connected to a base plate to fasten the face of the rail foot, or the second element rests on the base plate to fasten the face of the rail foot.

19. An elevator system comprising:
at least one assembly of elevator rails arranged in succession along a longitudinal axis, each of the elevator rails having a foot with faces; and
a plurality of the fastening devices according to claim 11, each of the fastening devices being associated with one of the faces, and each of the fastening devices enabling setting the holding dimension on the associated face of the rail foot.

20. A method for fastening a rail foot of an elevator rail with at least one of the fastening device according to claim 11, comprising the steps of:
mounting the at least one fastening device relative to a fastening plane; and
fastening the rail foot relative to the fastening plane by moving the first element of the at least one fastening device relative to the second element of the at least one fastening device in the adjustment direction.

21. The method according to claim 20 wherein the at least one fastening device is a first fastening device mounted on a first face of the rail foot, and including mounting a second fastening device on a second face of the rail foot opposite the first fastening device, wherein the first fastening device and the second fastening device fasten the rail foot in the adjustment direction but permit movement of the rail foot along a longitudinal axis of the elevator rail relative to the first fastening device and the second fastening device.
